(19) United States
(12) Patent Application Publication
(10) Pub. No.: US 2003/0012380 A1
(43) Pub. Date: Jan. 16, 2003

(54) Return channel for pay television decoder

(76) Inventor: Alan Guggenheim, Centennial, CO (US)

Correspondence Address: MCGLEW & TUTTLE, PC, SCARBOROUGH STATION, SCARBOROUGH, NY, 10510, US

(21) Appl. No.: 10/182,358

(22) PCT Filed: Jul. 23, 2001
(86) PCT No.: PCT/IB01/01317

(30) Foreign Application Priority Data
Jul. 24, 2000 (CH) 145800

(51) Int. Cl. H04N 7/16; H04N 7/167; H04L 9/00; H04K 1/00

(52) U.S. Cl. 380/266; 380/211; 725/1; 380/270

(57) ABSTRACT

In order to purchase television programs, it is necessary to establish a communication between the television decoder of the subscriber and a management center. There are known transmission means such as a modem or a cable link to dialogue with the management center.

Nevertheless, it can happen that these means are inoperative or simply unavailable in the considered configuration. That is why, according to the invention, the decoder comprises second transmission means such as a cellular phone, a modulator on the mains power line or a “Data Over Voice” type modulator.

The present invention concerns the field of pay television where a plurality of subscribers have a decoder called also Integrated Receiver Decoder (IRD), which permits the decryption of entering video and audio signals coming by known means.

The pay television systems are working correctly only when it exists a back channel that starts at the subscriber side and ends at the management center side. The most primitive version of this back channel consists in postal mailing containing information sent by the subscriber to the management center. In systems where the incoming video and audio signals use physical carriers like a cable or television network, the technical characteristics of this carrier allow information sending from the decoder to the management center by the same physical carrier. In many other transmission technologies of video and audio signals towards the subscriber, the back channel of the information consists in a phone line held by the subscriber working in general in a non exclusive manner as information back channel via a modulator-demodulator or modem and that usually at hours when the subscriber has a low opportunity to send or receive a phone call.

There is a today non-satisfactory solved problem in case the subscriber has no available phone line usable by the modem of the IRD. In such cases, it is possible that the subscriber's impulsive purchases of pay television programs are not correctly transmitted to the management center. All inconveniences relative to this lack of communication affect then the system and incite use of remedies poorly accepted by the subscriber and the television operator who proposes encrypted television programs to purchase.

In some cases, in order to avoid these inconveniences, the operator choose to refuse the impulsive purchasing coming from subscribers who have no working phone line to be used as back channel. The operators are loosing then revenues and the subscribers are unsatisfied because they cannot benefit from the impulsive purchasing possibilities.

This problem is solved by the means described in the characterizing part of the claim 1.

According to the invention, the system provides either an additional back channel for the information, which is used only when the current channel is defective or a channel qualified as secondary in the meaning that all classical channels are out of service in the considered case, and this secondary channel is the only manner to avoid the above-described inconveniences.

According to a first embodiment of the invention, the secondary back channel is wireless, that means it uses the frequencies reserved to the cellular or mobile phone. The decoder or IRD works then like a mobile phone by calling automatically the management center and by communicating with it, as it should do with a wire phone connection.

According to a second embodiment of the invention, the secondary back channel uses a non-foreseen physical carrier, the availability of which is usually guarantied in the building where the decoder is installed. It is the case, in particular, of the electrical conductors carrying the AC power at 220 V or 110 V, depending on the country. The availability of such conductors is based on that the usually known IRD have a mains plug permanently connected, even if present energy saving prescriptions incite deactivation of the mains at certain periods or hours in the day. In this embodiment of the invention, the operator has to make a deal with the electrical energy distributor, which leads to that the voltage transformers providing the electric power are equipped with electrical signal detectors. These detectors are able to recognize a return signal sent on the power lines by a specific decoder. These technologies are known by themselves and allow to the detector, downwards to the management center to which it is linked, to identify the specific decoder that has sent a message through this secondary channel. The physical realization can use for example a set of voltage peaks with an amplitude defined in order to make a compromise between the energy consumed by the decoder to produce such peaks and the compensation of power loss on the line, and with a periodicity defined to avoid that the noise on the line will be confused with the signal. This noise is due to for example the parasitic inductivity, Foucault currents or other interferences. The communication protocols used in this embodiment ensure the good reception of the messages by the signal detector like in case it exists a normal back channel.

According to a third embodiment of the invention, applied in particularly to the case of an existing phone line at the subscriber side, but when this line is almost permanently busy for example during constant facsimile transmission, the decoder sends information to the management center by means of the “Data Over Voice” technique. In this technique, remembering the preceding one under certain aspects, data are transmitted during a normal phone conversation at an inaudible frequency for the phone user, but on the other hand clearly recognizable by a signal detector connected on the phone line concentrator installed in the subscriber residence area.

1. Pay television decoder comprising means of information transmission to a management center, characterized in that these transmission means comprise first means such as a modem or cable and second transmission means when the first means are inoperative.

2. Pay television decoder according to claim 1, characterized in that the second transmission means consist of a cellular phone.

3. Pay television decoder according to claim 1, characterized in that the second transmission means consist of a modulator on the mains power line of the decoder.

4. Pay television decoder according to claim 1, characterized in that the second transmission means consist of a “Data Over Voice” type modulator.
